(19) United States
(12) Patent Application Publication
(10) Pub. No.: US 2008/0160150 A1
(43) Pub. Date: Jul. 3, 2008

(54) D-SHAPED TORTILLA

(76) Inventors: Kathryn L. Hupfer, Chicago, IL (US); Thomas E. Niedoborski, Des Plaines, IL (US)

Correspondence Address: FITCH EVEN TABIN & FLANNERY, 120 S. LASALLE STREET, SUITE 1600, CHICAGO, IL, 60603-3406, US

(21) Appl. No.: 11/618,256

(22) Filed: Dec. 29, 2006

(51) Int. Cl. A21D 10/00

(52) U.S. Cl. 426/549

(57) ABSTRACT

A D-shaped tortilla for wrapping around a filling is provided comprising a tortilla with a circular shaped segment and with ends intersected by a linear edge. At least one rounded side edge of the D-shaped tortilla may be folded around a filling and towards the center of the tortilla with the remaining tortilla folded or rolled up from the linear edge, which is positioned along a bottom edge, and into a generally cylindrical-shaped encasing. The D-shaped tortilla can provide less overlap of the edges at the center of the tortilla while still reducing or eliminating leakage of the filling.

### FIELD

A tortilla for wrapping around a filling, and in particular a D-shaped tortilla for wrapping around a filling.

### BACKGROUND

Soft-shell tortilla wraps have traditionally been used with Mexican cuisine. One common use is to take a circular soft-shell tortilla and place a food item in the center of the tortilla and to wrap the tortilla shell around it in a rolled, cylindrical shape. Recently, soft-shell tortillas have been used with many different varieties of cuisines and for many different food uses, such as breakfast wraps, lunch/dinner wraps and snack wraps.

Tortilla soft-shells are mostly sold in a circular configuration, however, there are also other geometric shapes such as a square-shaped tortilla, as listed in U.S. Pat. No. D516,275. Hard-shell taco shells, on the other hand, have been known to come in many different shapes and configurations. Hard shell taco shells are usually baked or fried to get a crispy outer texture. Furthermore, hard-shell taco shells are not made for rolling or wrapping, since the outer shell would most likely break. Rather the hard-shell taco shells are made with at least two upstanding sides having an open top for filling the shell with a food product. U.S. Pat. No. D393,136 discloses a box-shaped hard shell with an open top and four upstanding sides. U.S. Pat. No. D369,451 discloses a sea-shell shaped taco shell with an open top and four sides. U.S. Pat. No. 5,009,902, discloses a cone-shaped taco shell with an open top and the body of the hard shell rolled into a cone, where the taco shell is initially made from either a circular tortilla or a heart-shaped tortilla that is wrapped around a metal cone and then fried. Additionally, other fried tortilla food items, such as tortilla chips, may also come in a variety of shapes, such as a relatively flat fish shape, as disclosed in U.S. Pat. No. D383,588, however these chips also have hard shells and cannot be rolled after they are made without breaking. The taco shell tortillas and tortilla chips contain hard shells and do not hold up well if they are rolled, as the outer shell becomes very fragile after the baking/frying steps and can crack or break. Therefore, hard-shell tortilla shells and chips do not perform well with the variety of wrapped foods that soft-shell tortillas do.

A common issue with rolled, circular soft shell tortillas is that the food item placed in the middle of the tortilla and subsequently wrapped has a tendency to fall out of the open ends or to leak out of the open ends upon heating and/or eating. To resolve this problem, circular tortillas are often folded in at the ends before rolling, so that the ends are not open but are at least partially closed to contain the filling inside the rolled tortilla. To provide enough tortilla material at the ends of a circular tortilla for folding inwards before rolling, a larger sized circular tortilla is often utilized to allow for adequate material at the ends to try to prevent the filling from spilling or leaking out of the wrapped tortilla product. However, as the circular tortilla gets larger in diameter, there is a greater overlap of tortilla product along a center line of the wrapped tortilla, which may result in the tortilla drying out in the center due to a larger amount of the tortilla being on the outside of the wrapped product such that the tortilla along the outside is not in direct contact with the filling and is not kept moist through contact with the filling inside. Such actions like heating, cooking, and/or air exposure tend to accelerate the tortilla drying out. Further, the wrapped circular tortillas contain an undesirable amount of tortilla material along the center that can hinder chewing, and may negatively affect the overall appearance, nutritional profile and flavor of the finished product. The large, circular tortilla may also have a thick, doughy taste, thus appearing more chewy to the consumer and having an overly tough mouthfeel.

The tortilla manufacturing process typically involves two variations: either creating a ball of dough and pressing the ball of dough flat into a circle, as disclosed in U.S. Pat. No. 4,281,025, or sheeting the dough flat and cutting or stamping out the pieces. When the dough is sheeted, it is stretched and pulled in various directions and the strength of the dough weakens, thus forming a plane of weakness along which the dough is weakest and may be easily torn. The plane of weakness is the weakest cross-tensile strength across the tortilla and develops such that if the tortilla dough is pulled in one direction it may tend to come apart or tear but if pulled in another direction it may tend to remain intact. The drawback with a circular shaped tortilla is that the location of the plane of weakness can be difficult to identify given the circular shape, and if handled at an inappropriate angle to the plane of weakness can fall apart.

### SUMMARY

A D-shaped tortilla for wrapping around a filling comprising a tortilla having a circular shaped segment with ends intersected by a linear edge is provided. In use, at least one rounded side edge of the D-shaped tortilla may be folded around a filling and towards the center of the tortilla with the remaining tortilla folded or rolled up from the linear edge, which is positioned along a bottom edge, and into a generally cylindrical-shaped encasing.

There are manufacturing benefits associated with the D-shaped tortilla. The positioning of the linear edge of the D-shape aids in providing a visual indication as to where a plane of weakness in the tortilla wrap may be located when the dough is prepared by sheeting, which may be important when the tortilla is advanced on a conveyor or the like or rolled and/or folded into a food wrap item. The linear edge of the D-shaped tortilla may be placed at an angle, such as from about 0° to about 90°, and preferably at about a 45° angle, to a sheeting direction of the tortilla dough, which typically provides for a plane of weakness at a corresponding angle, such as about a 45° angle, to the linear edge of the D-shaped tortilla. Knowing where the plane of weakness is allows the wraps to be folded to avoid the plane of weakness and without the wrap coming apart or weakening. Furthermore, when the D-shaped tortilla wrap is folded, it can be done so in such an orientation that there is less tortilla product overlapping at the center location of the wrap, thus providing the consumer with the perception that there is less dough contained in the wrap than a circular tortilla wrap, when there may actually be the same amount of dough but wrapped differently. As a result, the D-shaped tortilla wrap may taste less chewy than a circular tortilla wrap and may avoid drying out in the center because there is less of the wrap concentrated in the middle section of the wrap.

Additionally, the D-shaped tortilla may be wrapped in such a manner that aids in minimizing leakage or spillage of a filling or food product contained within the tortilla wrap. This may be done by folding in, or tucking in, the ends of the wrap to help contain the filling inside of the wrap. The D-shape of the D-shaped tortilla provides excess tortilla product at the ends when folded, to allow for easier encasing of the filling, as well as providing a reduced amount of tortilla overlap in the center of the product. As a result, the ratio of tortilla to filling is not undesirably large.

In a method of manufacture, the D-shaped tortilla may be made by first sheeting tortilla dough onto a flat surface in a machine direction and directing the sheeted dough to a position beneath a cutting device or station. The sheeted dough is then cut into a D-shaped dough portion using a cutting device. The D-shaped dough portion is directed in a machine direction such that a linear edge of the D-shaped dough portion is inclined at an angle to the machine direction, and preferably that angle of incline is 45 degrees. The D-shaped dough portion is then sent to an oven and is baked, resulting in the D-shaped tortilla.

The cutting device utilized to cut the D-shaped tortilla may comprise many suitable arrangements, and in particular may comprise a flat cutter and/or a rotary wheel cutter. Both cutters may have a raised knife portion, such as raised blades, which are configured in a slightly off-center D-shape so that the dough is able to snap back after cutting and baking to a symmetrical D-shape.

### BRIEF DESCRIPTION OF THE DRAWINGS

FIG. 1 is a plan view of a D-shaped tortilla;

FIG. 2 is a perspective view of a general process line for manufacturing the D-shaped tortillas of FIG. 1;

FIG. 3 is a bottom plan view of a flat cutter used at a cutting station of the general process line of FIG. 2;

FIG. 4 is a perspective of a rotary cutter used at a cutting station of the general process line of FIG. 3;

FIG. 5 is a schematic of folding steps for obtaining a single open-ended tortilla wrap; and

FIG. 6 is a schematic of folding steps for obtaining a close-ended tortilla wrap.

### DETAILED DESCRIPTION

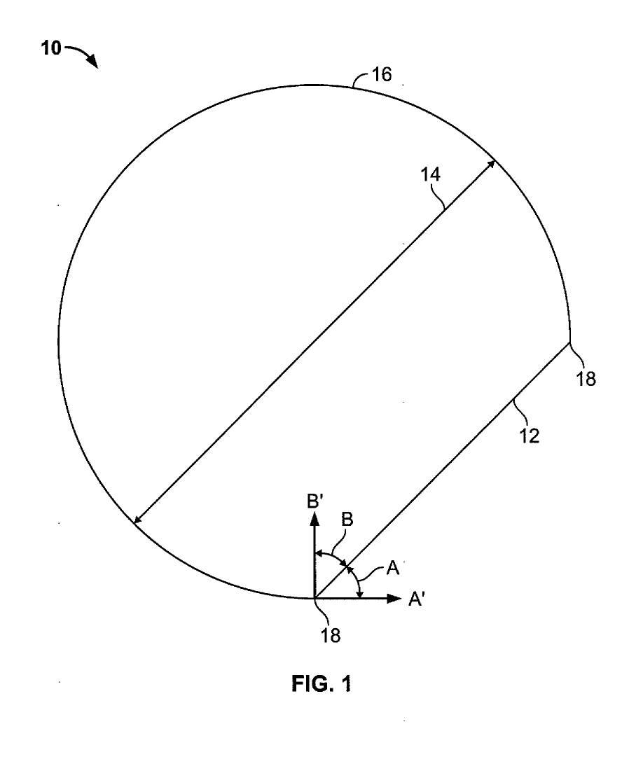

A tortilla for wrapping around a filling, and in particular a D-shaped tortilla for wrapping around a filling, and methods of manufacture and wrapping around a filling, are disclosed herein and illustrated in FIGS. 1-6. A D-shaped tortilla is provided by cutting a circular shaped segment out of tortilla dough having ends intersected by a linear edge, such that the linear edge is created in one side of a circular tortilla forming a chord of a circle. The linear edge is typically between an angle of about 0° and about 90°, such as about a 45° angle, to a machine or sheeting direction, although other angles may be used. The D-shaped tortilla also helps to further define a plane of weakness within the tortilla product at which the tortilla weakens and can tear apart if pulled along that plane, typically positioned at about a 45° angle to the linear edge direction. The D-shaped tortilla can be folded around a filling or food product to form a cylinder-like configuration, such that at least one of the ends is enclosed to minimize product leakage and spillage. The D-shaped tortilla is further folded to create a wrap food product having less overlap of tortilla material along the centerline of the wrap than a traditional, circular tortilla.

A D-shaped tortilla 10, as illustrated in FIG. 1, is provided having a circular edge 16 and a linear edge 12, and where the D-shaped tortilla 10 further may have a diameter 14 defined by the greatest distance from one circular edge 16 to an opposite circular edge 16. The circular edge 16 may have ends 18 that are intersected by the linear edge 12. The linear edge 12 may typically be positioned at a 45° angle to a sheeting direction. The sheeting direction is the direction that the tortilla dough is stretched and pulled in to create a sheet of dough. The sheeting direction may often be the same direction as a machine direction of the process. For example, if the sheeting direction is in a direction A′, as shown by the arrow A′, then the linear edge 12 is at a 45° angle to the sheeting direction A′, as shown by the angle A. Alternatively, if the sheeting direction is in a direction B′, as shown by the arrow B′, then the linear edge 12 is at a 45° angle to the sheeting direction B′, as shown by the angle B. The direction/angle of the linear edge 12 becomes important during the manufacturing process to define the plane of weakness when the tortilla 10 is being wrapped, described in more detail below.

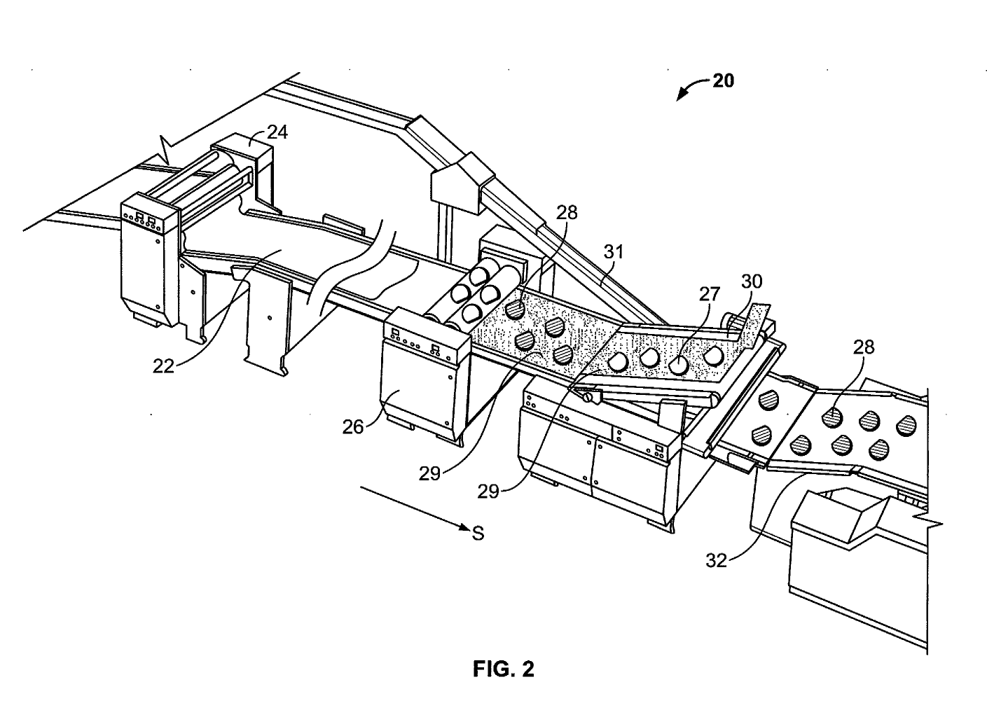

Turning to the method of manufacture, as illustrated in FIG. 2, the process line 20 is shown after the dough has been sheeted along a conveyor belt to form a dough sheet 22. The dough sheet 22 may pass through gauge rollers 24, such that the dough may be thinned out and flattened into a substantially even sheet of dough. As the dough passes through gauge rollers 24, the rolling action may pull the dough in a machine direction, also referred to as a sheeting direction, as represented by the arrow S, which may result in a plane of weakness forming in the dough sheet 22. The plane of weakness typically forms in a direction perpendicular to the sheeting direction such that if it is pulled or handled along the plane of weakness the dough may become susceptible to further weakening and may come apart if handled further. When the tortilla dough sheet 22 is cut into circular shapes, the plane of weakness cannot easily be identified since once the circular shape is cut from the sheeted dough, all of the edges are alike and hence the sheeting direction and subsequently the plane of weakness can no longer be easily identified. However, with the D-shaped tortilla 10 cut into the dough sheet 22, the linear edge 12 of the tortilla 10 may act as an indicator that easily identifies the plane of weakness. For example, where the plane of weakness is perpendicular to the sheeting direction S, and the linear edge 12 is at a 45° angle to the sheeting direction, the plane of weakness would also be at a 45° angle to the linear edge 12. Therefore, when the D-shaped tortilla 10 is handled, it can be handled such that any force applied to the D-shaped tortilla 10 is at about a 45° angle to the plane of weakness, or the plane perpendicular to the sheeting direction, as identified by the linear edge 12. Handling and wrapping the D-shaped tortilla 10 becomes easier than a circular tortilla with less tortillas becoming damaged because the plane of weakness can be avoided upon rolling the D-shaped tortilla 10 into a wrap, whereas the plane of weakness is not easily avoided upon rolling a circular tortilla since the location of the plane of weakness is not easily ascertained.

After the dough has been sheeted to the desired thickness, the dough sheet 22 advances to a cutting station 26, where the dough sheet 22 is cut into the desired D-shape. The cutting station 26 may comprise any number of cutting devices traditionally used to cut tortilla dough, and in particular may comprise a flat and/or rotary cutter. A flat cutter 34, as shown in FIG. 3, may be used such as a die press, that is in a raised position as the dough sheet 22 advances beneath it in the machine direction S, and is then in a lowered position placed on top of the dough sheet 22 as the dough sheet 22 is cut. The flat cutter 34 comprises a flat surface, with a raised knife edge 38 that is configured in a slightly off-center D-shape. As the flat cutter 34 is lowered onto the dough sheet 22, the raised knife edge 38 contacts the dough sheet 22 and cuts it relatively simultaneously into a D-shaped dough portion 28, as shown in FIG. 2. The rounded portion of the raised knife edge 38 is slightly elongated or skewed such that after the dough sheet 22 is cut, the dough sheet 22 is allowed to snap back, such that the edges contract slightly, after the blades of the knife edge 38 are removed and even further upon baking, thus becoming more of a symmetrical D-shape than as it was being cut. The flat cutter 34 comprises at least one D-shaped cutting device, and preferably a plurality of D-shaped cutting devices.

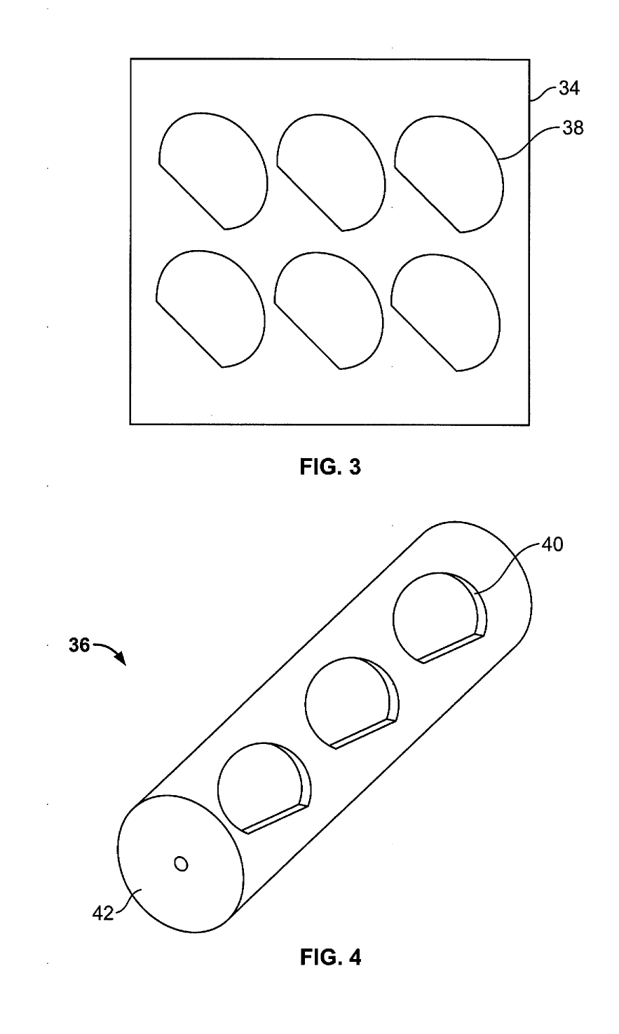

Another cutting device may comprise a rotary cutter 36, as shown in FIG. 4, which comprises a round wheel 42 that rotates about an axis; The wheel 42 contains a raised knife edge 40 that cuts the dough sheet 22 as the wheel 42 is rotated onto the dough sheet 22. The raised knife edge 40 may also be configured in a slightly off-center, or skewed, D-shape and may comprise at least one, and in particular a plurality, of D-shapes. The D-shape cutting device of the raised knife edge 40 is placed onto the dough sheet 22 in stages as it is rotated on its axis, thus cutting the dough sheet 22 progressively into a D-shape portion 28 as the different sides of the knife edge 40 come into contact with the dough sheet 22.

The dough sheet 22 continues down the process line in a machine direction S, after passing the cutting station 26. The dough sheet 22 contains D-shape portions 28 cut into the dough sheet 22 upon exiting the cutting station 26. As the dough sheet 22 with D-shape portions 28 advances down the line, a dough lattice portion 29 passes onto an upper conveyor and scrap lift station 30 where the dough lattice 29 is lifted away from around the D-shape portion 28, leaving a D-shaped space 27 within the dough lattice 29. The dough lattice 29 may then be carried back through the process, such as through a scrap return system 31, to be reworked and reincorporated into a subsequent dough batch. As the dough lattice 29 is lifted away by the upper conveyor of the scrap lift station 30, the D-shape portions 28 continue along the process line 20, below the upper conveyor 30, and onto a lower conveyor 32. After the dough lattice 29 is removed from around the D-shape portion 28, the D-shaped tortilla dough portions 28 can be sent to the ovens along the lower conveyor 32 and may be baked. The D-shaped tortilla dough portions 28 may contract slightly after cooking such that the slightly skewed or off-center D-shape snaps back, or contracts, to a more symmetrical D-shape than when first cut.

Alternatively, the D-shaped tortilla 10 may also be made by other common methods, such as by creating a ball of dough and pressing it into a circle. Once a circle of dough is made then an edge of the circle may be cut to create the linear edge of the D-shaped tortilla. The dough may be thereafter sent to the oven and baked. Although specific examples of methods of manufacturing D-shaped tortillas are discussed, other methods that result in the disclosed D-shaped tortillas may be used.

Once the D-shaped tortilla dough 28 is baked, the D-shaped tortilla 10 is completed and ready to be used as a food wrap item. The D-shaped tortilla 10 can be used with any type of food filling that would utilize a wrap, such as breakfast wraps, burrito wraps, Mexican food item wraps, Asian food item wraps, and the like. The D-shaped tortilla 10 may be used to produce a wrap, an egg roll, a roll-up, burrito-style food, and the like. Possible food fillings may comprise meats, vegetables, rice, cheese, sauce, and any combination thereof. The dough material used may comprise any type of dough that may typically be used to make a tortilla, such as a corn-based dough, a wheat-based dough, a rice-based dough, and combinations thereof. The same amount or weight of dough may be used to make the D-shaped tortilla as with a comparable circular tortilla such that the same nutritional requirements are met, however the consumer may perceive a less amount of dough in the tortilla as they are eating it because of the way it is cut and folded. Optionally, a less amount of dough may also be used to make the D-shaped tortilla if a cost-savings is desired.

The dimensions of the D-shaped tortilla may be any size typically used with tortilla wrap products, and may generally include D-shaped tortillas 10 with diameters 14 from about 4 inches to about 16 inches, from one circular edge 16 to the opposite circular edge 16 and may be chosen depending upon the quantity, shape and/or viscosity of the filling product desired. Various positions of the linear edge may also be possible. The linear edge may be cut so that the chord, or straight edge, of the linear edge is at the largest distance from the center diameter 14 of the tortilla 10, or it may be positioned such that it is as close to the center diameter 14 of the tortilla center and still be able to function as a wrap. However, there may be an optimal location of the linear edge at a certain distance away from the diameter 14, or center of the circle, such that the tortilla wrap may still contain a comparable quantity of dough to a circular tortilla made with the same quantity of dough, such that its nutritional value may be the same. One example of a D-shaped tortilla 10, may be a tortilla having a diameter 14 of about 9 inches, with a linear edge 12 that is about 7 inches long. The distance from the center of the linear edge 12 to the opposite circular edge 16 may be about 7.4 inches long. The linear edge 12 would of course be cut such that it is at about a 45° angle to the sheeting direction S of the dough.

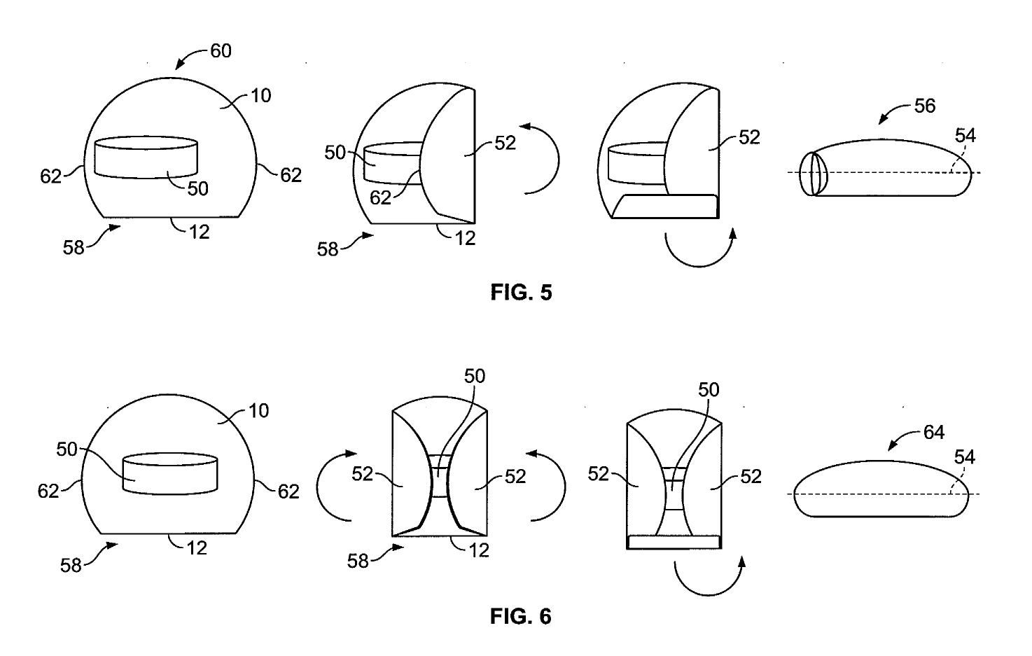

The D-shaped tortilla 10 may be formed into a single open-ended food product wrap 56 such that at least one of the ends of the wrap 56 is folded in, or tucked in, about a filling 50 to prevent or minimize leakage and such that the amount of tortilla overlap along a centerline 54 is minimized to reduce a chewy, doughy feel upon consuming the wrap product 56. A schematic of a possible folding option is shown in FIG. 5, where the D-shaped tortilla 10 is folded into a cylinder-shaped wrap 56 with at least one end folded in. The D-shaped tortilla may be placed in a flat position such that the linear edge 12 of the D-shaped tortilla 10 is at a bottom position 58. The filling 50, or food product, may then be placed on top of the tortilla 10 and substantially equidistant from the rounded top portion 60 and the linear edge 12 of the bottom portion 58. Preferably the filling 50 may be placed off-center along a longitudinal plane of the tortilla, i.e., such that it is closer to one of the circular side edges 62 than the other, and when one of the tortilla wrap ends is left open the filling 50 may be more visible and accessible from that end. The tortilla 10 may then be folded in towards the center from one of the side edges 62, and folded up over the filling 50. Then, the tortilla 10 may be folded up over the folded side edge 52 from the bottom edge 58, or the linear edge 12, by bringing the linear edge 12 up and over the folded side edge 52 and filling 50 and rolling the tortilla 10 into a cylinder-shape until the filling 50 is substantially covered with the tortilla wrap, with the exception of the one open end.

Alternatively, a generally closed tortilla wrap product 64 may be formed such that substantially none of the filling 50 or food product is visible from the outside of the wrap 64, as shown in FIG. 6. The D-shaped tortilla 10 is placed in a similar position as with the single open-ended wrap 56, except that now the food product or filling 50 may be placed in approximately the middle of the D-shaped tortilla 10. In this aspect, both side edges 62 of the tortilla 10 are folded up and over the filling 50 and towards the center of the tortilla. Once the side edges are both folded in to form a folded side edge 52, then the bottom edge 58 comprising the linear edge 12 is rolled up and over both folded side edges 52 and the filling 50, such that a cylinder-shaped wrap 64 is made. The end may be kept closed by positioning the finished tortilla such that the wrapped, overlapped end faces downwards in the packaging. Alternatively, the wrapped tortilla may be frozen with the overlapped end in a downward position to allow gravity to hold it in place, or still alternatively, an edible adhesive may be used. This orientation of the tortilla wrap helps to minimize the filling from leaking or spilling out of either end of the tortilla wrapped food product upon heating or consuming the product. Additionally, the amount of tortilla overlap along a centerline 54 is minimized to reduce a chewy, doughy feel upon consuming the wrap product.

From the foregoing, it will be appreciated a D-shaped tortilla is provided that allows for wrapping around a filling, and methods of manufacture thereof. However, the disclosure is not limited to the aspects and embodiments described hereinabove, or to any particular embodiments. Various modifications to the D-shaped tortilla and methods of manufacture and filling can result in substantially the same D-shaped tortilla and methods of filling.

What is claimed is:

1. A method of making a D-shaped tortilla for wrapping around a filling comprising:
sheeting a tortilla dough onto a flat surface in a machine direction;
directing the tortilla dough in the machine direction to a position beneath a cutting device;
cutting a D-shaped dough portion from the sheeted tortilla dough with the cutting device;
directing the D-shaped dough portion in the machine direction, a linear edge of the D-shaped dough portion being inclined at an angle to the machine direction; and
baking the cut dough in an oven.

2. The method of claim 1, further comprising removing a scrap lattice from around the D-shaped dough portion after cutting with the cutting device.

3. The method of claim 1, wherein the cutting device contains a slightly off-center D-shape cutter to cut a slightly off-center D-shape into the dough prior to baking.

4. The method of claim 3, wherein the cutting device comprises a rotary wheel cutter with raised blades thereon configured in one or more slightly off-center D-shapes, and the wheel rotating about an axis and the method further comprising cutting the sheeted dough as the wheel rotates onto the dough.

5. The method of claim 3, wherein the cutting device comprises a flat cutter that has a cutting edge configured in one or more D-shapes, and the method further comprising shifting the cutter in a normal direction relative to a plane generally defined by the sheeted dough to cut the dough.

6. The method of claim 1, wherein the angle is from about 0 degrees to about 90 degrees.

7. The method of claim 6, wherein the angle is about 45 degrees.

8. A tortilla for wrapping around a filling, the tortilla comprising:
a D-shaped tortilla having a circular shaped segment with ends intersected by a linear edge.

9. The tortilla of claim 8, wherein the tortilla has a diameter in a range from about 4 inches to about 16 inches from a circular edge of the tortilla to an opposite circular edge.

10. The tortilla of claim 8, wherein the tortilla is folded around the filling by first folding at least one rounded side edge towards the center of the tortilla and over the filling, such that the straight edge of the tortilla is positioned along a bottom edge, and then rolling the remainder of the tortilla towards the center and over the filling to form a cylinder encasing.

11. The tortilla of claim 8, wherein the filling is selected from the group consisting of meats, vegetables, rice, cheese, sauce and any combination thereof.

12. The tortilla of claim 8, wherein the dough is selected from the group of corn-based, wheat-based, rice-based, and any combinations thereof.

13. The tortilla of claim 8, wherein the tortilla is configured into a form having one of a wrap, an egg roll, a roll-up, a burrito-style food and other similar configurations.

14. The tortilla of claim 8, wherein the linear edge has an angle that is positioned from about 0 degrees to about 90 degrees to a sheeting direction.

15. The method of claim 14, wherein the angle is about 45 degrees.
